(19) United States
(12) Patent Application Publication
(10) Pub. No.: US 2012/0231639 A1
(43) Pub. Date: Sep. 13, 2012

(54) SURFACE-MOUNT CONNECTER AND SUBSTRATE UNIT

(75) Inventor: Yoko MURATA, Kawasaki (JP)

(73) Assignee: FUJITSU LIMITED, Kawasaki-shi (JP)

(21) Appl. No.: 13/407,853

(22) Filed: Feb. 29, 2012

(30) Foreign Application Priority Data
Mar. 8, 2011 (JP) 2011-050696

(51) Int. Cl. H01R 12/00; H01R 13/10

(52) U.S. Cl. 439/78; 439/682

(57) ABSTRACT

A surface-mount connector includes an enclosure, and a plurality of terminals that is mounted in the enclosure, one end of each of terminals being joined to a surface of a substrate, another end of each terminal fitting into a terminal of a connector that is to be fitted into the surface-mount connector, wherein each of the terminals is mounted in the enclosure so as to be movable within a restricted range in directions to come into contact with and separate from the substrate.

### CROSS-REFERENCE TO RELATED APPLICATION

This application is based upon and claims the benefit of priority of the prior Japanese Patent Application No. 2011-050696, filed on Mar. 8, 2011, the entire contents of which are incorporated herein by reference.

### FIELD

The embodiment discussed herein is related to a surface-mount connector and a substrate unit.

### BACKGROUND

Surface-mount connectors that connect terminals have been used in recent years.

FIG. 1 is a perspective view of a pin connector 101, which is a surface-mount connector of the related art.

The pin connector 101 includes an enclosure 1001 made of resin, such as a polyamide resin. The enclosure 1001 has an open-top hollow portion 1001a. Multiple electrically conductive pin terminals 1002, which protrude upward, are arranged in two rows inside the hollow portion 1001a. The pin terminals 1002 are made of a metal such as a nickel-base alloy or brass. A receptacle connector, which is not illustrated and which is to be fitted into the pin connector 101, is inserted from the open top, and thus the pin terminals 1002 of the pin connector 101 fit into multiple terminals of the receptacle connector. The pin connector 101 also includes lower terminals 1002a that penetrate through a bottom portion of the enclosure 1001 and are then bent sideways.

As illustrated in FIG. 2, each of the multiple pin terminals 1002 is formed integrally with a corresponding one of the L-shaped lower terminals 1002a. Specifically, each pin terminal 1002 includes, in order from top to bottom, a pointed portion 1002b that is tapered toward the top, a first cylindrical portion 1002c, a second cylindrical portion 1002d, and a lower terminal 1002a formed by an L-shaped cylinder that has a smaller diameter than the second cylindrical portion 1002d.

As illustrated in FIG. 3, a bottom plate 1001b of the enclosure 1001 has multiple through holes 1001c that allow the pin terminals 1002 to be inserted therethrough and to be fixed thereto. The through holes 1001c are arranged so as to correspond to the arrangement of the pin terminals 1002. Each through hole 1001c includes a first cylindrical hole 1001c1 that is open to the upper side of the bottom plate 1001b, and a second cylindrical hole 1001c2 that is open to the lower side of the bottom plate 1001b and that has a larger diameter than the first cylindrical hole 1001c1. The first cylindrical hole 1001c1 and the second cylindrical hole 1001c2 are connected to each other.

As illustrated in FIG. 4, the inner diameter of each first cylindrical hole 1001c1 and the diameter of the first cylindrical portion 1002c of each pin terminal 1002 are equal to each other, i.e., both are D1, which is 0.3 mm. Each second cylindrical hole 1001c2 has an inner diameter D2 of 0.4 mm. The diameter of the second cylindrical portion 1002d of each pin terminal 1002 is equal to the inner diameter D2 or larger by around 0.01 mm. The height of each second cylindrical hole 1001c2 and the height of each second cylindrical portion 1002d are equal to each other, i.e., both are H1.

As illustrated in FIG. 5, in the pin connector 101, the pin terminals 1002 are inserted into the through holes 1001c from the lower side of the bottom plate 1001b of the enclosure 1001.

FIG. 6 is an enlarged sectional view of a portion of the pin connector 101 that has been assembled in a manner illustrated in FIG. 5, taken along line VI-VI (see FIG. 1).

As illustrated in FIG. 6, the pin terminals 1002 are inserted from the side to which the second cylindrical holes 1001c2 are open, until the second cylindrical portions 1002d become housed in the second cylindrical holes 1001c2. As described above, the diameter of the second cylindrical portion 1002d of each pin terminal 1002 is equal to the inner diameter D2 of each second cylindrical hole 1001c2 or larger by around 0.01 mm. Despite this, the second cylindrical portion 1002d of each pin terminal 1002 can still be inserted into and housed in the corresponding second cylindrical hole 1001c2 as illustrated in FIG. 6, because the enclosure 1001 is made of a resin and thus is elastic. Thus, inner walls of the through holes 1002c are brought into close contact with the second cylindrical portions 1002d of the pin terminals 1002, and the pin terminals 1002 are fixed at predetermined positions in the enclosure 1001.

Next, how to mount the pin connector 101 on a substrate will be described.

As illustrated in FIG. 7, for mounting the surface-mount pin connector 101 on a substrate 102, electrically conductive patterns 1021 that correspond to the lower terminals 1002a of the pin connector 101 are formed in advance on a surface of the substrate 102. For convenience of illustration, FIG. 7 only illustrates the electrically conductive patterns 1021, but other electrically conductive patterns including wirings that are connected to the electrically conductive patterns 1021 are actually formed on the substrate 102.

As illustrated in FIG. 8, the lower terminals 1002a are placed on the electrically conductive patterns 1021 to which soldering paste portions 1022 have been applied, and then subjected to heating, so that the soldering paste portions 1022 melt. Thus, the electrically conductive patterns 1021 and the lower terminals 1002a are joined to one another.

The substrate 102, however, is not completely flat, and is somewhat warped.

When the surface-mount pin connector 101 is placed on a substrate that is warped as described above, some lower terminals 1002a may fail to come into direct contact with the corresponding electrically conductive patterns 1021 of the substrate 102, as illustrated in FIG. 9. Generally, a thermosetting epoxy resin coating called a solder resist is applied to the surface of the substrate 102 except for at regions that are to be soldered (also referred to as “to-be-soldered regions”). Since the solder resist repels melted solder, the soldering paste portions 1022, after being melted, are repelled by regions of the substrate 102 other than the regions corresponding to the electrically conductive patterns 1021. Thus, the melted soldering paste portions 1022 form balls on the top of the electrically conductive patterns 1021. For this reason, the lower terminals 1002a and the electrically conductive patterns 1021 are joined to one another even when separated from one another by a certain distance due to the warpage of the substrate 102 as in the region indicated by C in FIG. 10. Most multilayer substrates that have been used heretofore achieve a certain level of flatness because the multilayer substrates each have a base board containing a core material, such as a glass epoxy curable resin, on which multiple layers are formed in order to retain the flatness. Thus, the substrate 102 is not considerably warped, and the ball-shaped melted soldering paste portions 1022 allow the lower terminals 1002a to be joined to the electrically conductive patterns.

However, so-called coreless substrates, even of a large size, have been used in response to a demand for thin substrates to reduce the weight and the cost of built-in components. Unlike a substrate containing a core material that retains a predetermined level or higher of surface flatness as a result of the strength of the core material, a coreless substrate that does not contain a core material has low strength and thus is warped easily.

As illustrated in FIG. 11, the warpage may produce such a large gap between a lower terminal 1002a and the corresponding electrically conductive pattern 1021, that even a ball-shaped melted soldering paste portion 1022 does not compensate for.

A conceivable countermeasure against this problem is to increase the amount of material in the soldering paste portions 1022 to be applied and thus make larger balls out of the melted soldering paste portions 1022. However, increasing the amount of material in the soldering paste portions to be melted may lead to joining (short-circuiting) of adjacent electrically conductive patterns even if a solder resist is applied to the surface of the substrate 102. Thus, the increase in the amount of material in the soldering paste portions to be applied is subjected to a certain limit.

A pin connector illustrated in FIG. 12 has been made to deal with the above problem. The pin connector includes coil springs 1002f instead of the second cylindrical portions 1002d of the pin terminals 1002, and a retaining board 1003 that restrains the pin terminals 1002 from moving downward.

As illustrated in FIG. 13, a connector 101 is fastened while being urged toward a connector substrate 102 in a state where lock mechanisms 103 disposed on the connector substrate 102 press down on protrusions (not illustrated) formed on both sides of the connector 101.

When the connector 101 is fastened in this manner, the coil springs 1002f each expand or contract so as to follow the warpage of the substrate 102 and thus all the lower terminals 1002a come into contact with the electrically conductive patterns on the substrate 102, as illustrated in FIG. 14. Thus, the lower terminals 1002a and the electrically conductive patterns 1021 come into contact with and are fixed to one another even when the substrate 102 has a certain amount or more of warpage.

Japanese Laid-open Patent Publication No. 2006-294308 describes an example of the related art.

### SUMMARY

According to an aspect of the invention, a surface-mount connector includes an enclosure, and a plurality of terminals that is mounted in the enclosure, one end of each of terminals being joined to a surface of a substrate, another end of each terminal fitting into a terminal of a connector that is to be fitted into the surface-mount connector, wherein each of the terminals is mounted in the enclosure so as to be movable within a restricted range in directions to come into contact with and separate from the substrate.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a perspective view of a pin connector of the related art;

FIG. 2 is a perspective view of a pin terminal of the related art;

FIG. 3 is a sectional view of an enclosure of the pin connector of the related art;

FIG. 4 illustrates a relationship between the pin terminal and a through hole formed in a bottom plate of the pin connector of the related art;

FIG. 5 is an exploded perspective view of the pin connector of the related art;

FIG. 6 is a sectional view of a main portion of the pin connector of the related art;

FIG. 7 illustrates a main portion of a surface of a substrate on which the pin connector of the related art is mounted;

FIG. 8 illustrates how the pin connector of the related art is mounted on the substrate;

FIG. 9 is a sectional view of the pin connector of the related art that is mounted on the substrate;

FIG. 10 is a sectional view of a main portion of the pin connector of the related art that is mounted on the substrate;

FIG. 11 is a sectional view of a main portion of the pin connector of the related art that is mounted on a considerably warped substrate;

FIG. 12 illustrates a pin terminal of another pin connector of the related art;

FIG. 13 is a perspective view of the another pin connector of the related art that is mounted on the substrate;

FIG. 14 is a sectional view of a main portion of the another pin connector of the related art that is mounted on a substrate;

FIG. 15 is a perspective view of a pin connector according to an embodiment;

FIG. 16 is a perspective view of a pin terminal according to the embodiment;

FIG. 17 is a sectional view of an enclosure of a pin connector according to the embodiment;

FIG. 18 illustrates a relationship between the pin terminal and a through hole formed in a bottom plate of the pin connector according to the embodiment;

FIG. 19 is an exploded perspective view of the pin connector according to the embodiment;

FIG. 20 is a sectional view of a main portion of the pin connector according to the embodiment;

FIG. 21 illustrates a main portion of a surface of a substrate on which the pin connector according to the embodiment is mounted;

FIG. 22 illustrates how the pin connector according to the embodiment is mounted on the substrate;

FIG. 23 is a sectional view of the pin connector according to the embodiment that is mounted on the substrate;

FIG. 24 is a sectional view of a main portion of the pin connector according to the embodiment that is placed on the substrate;

FIG. 25 is a sectional view of the main portion of the pin connector according to the embodiment that is mounted on the substrate;

FIG. 26 is a sectional view of a main portion of a pin connector according to a comparative example that is placed on the substrate; and

FIG. 27 is a sectional view of the main portion of the pin connector according to the comparative example that is mounted on the substrate.

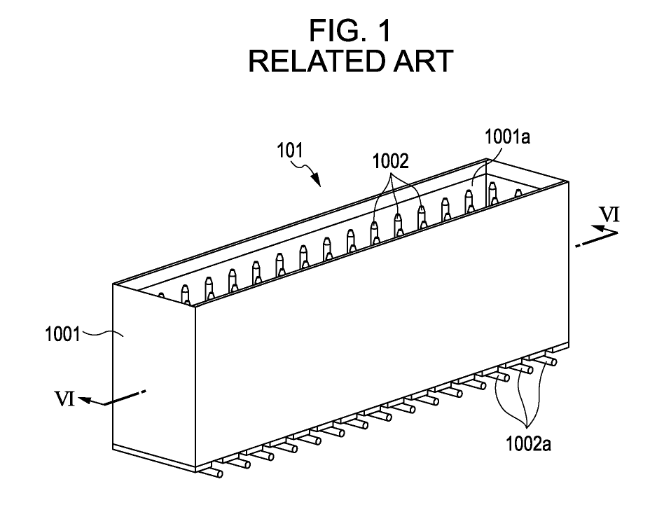

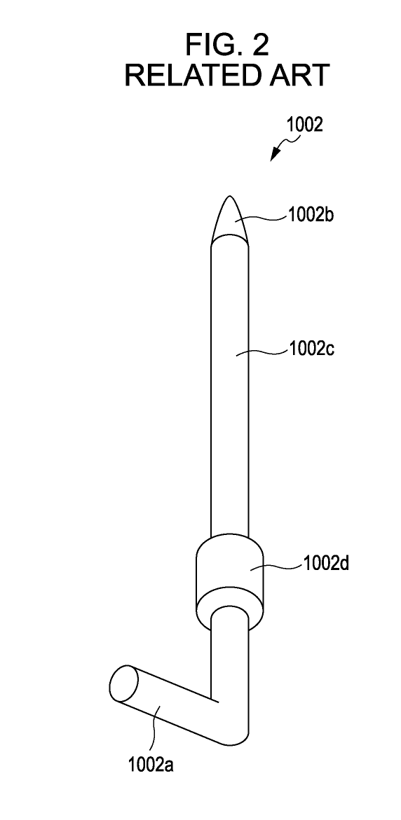

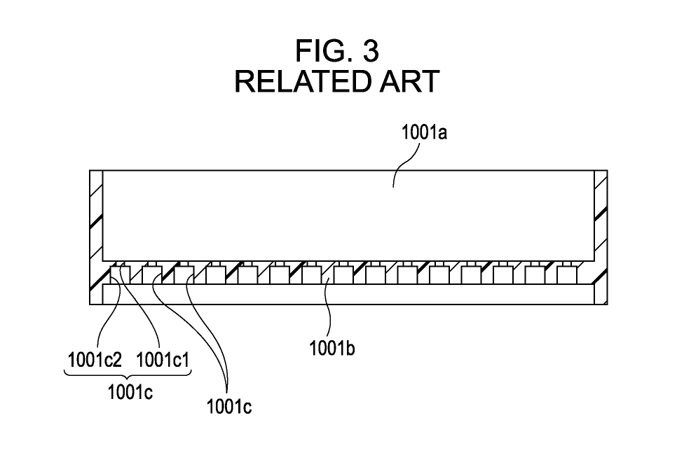

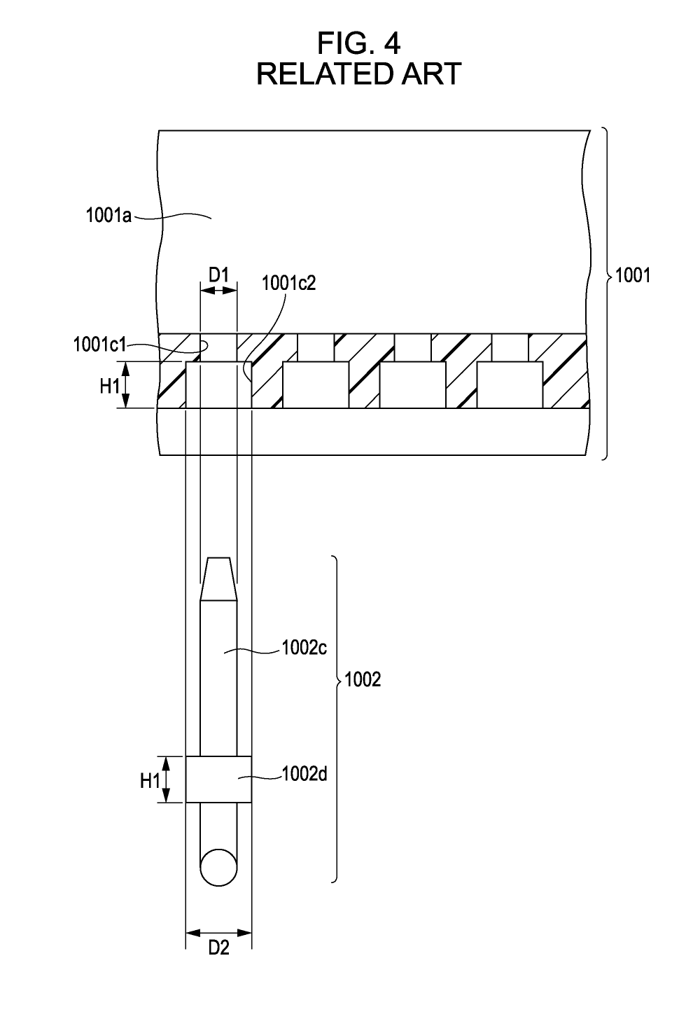

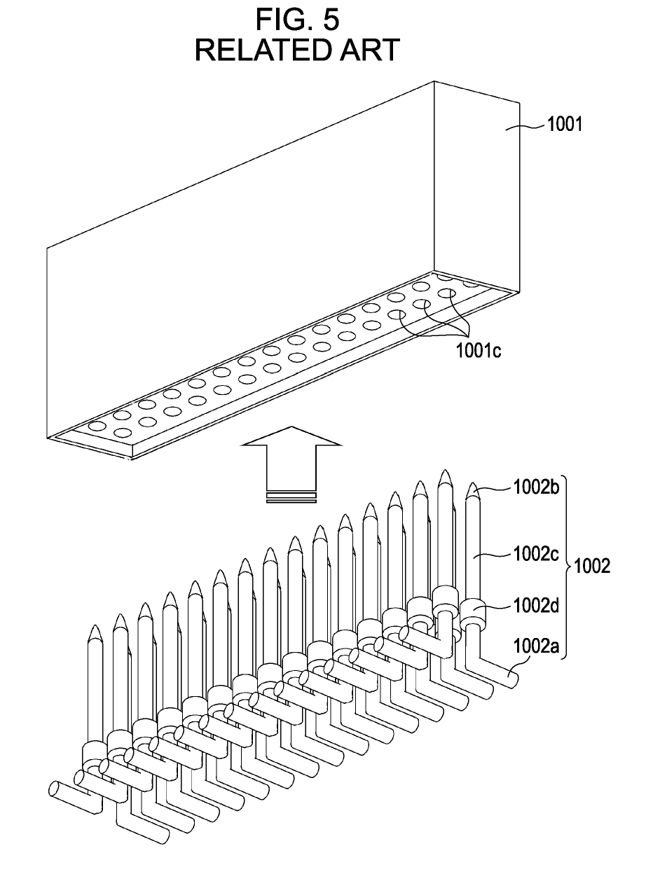

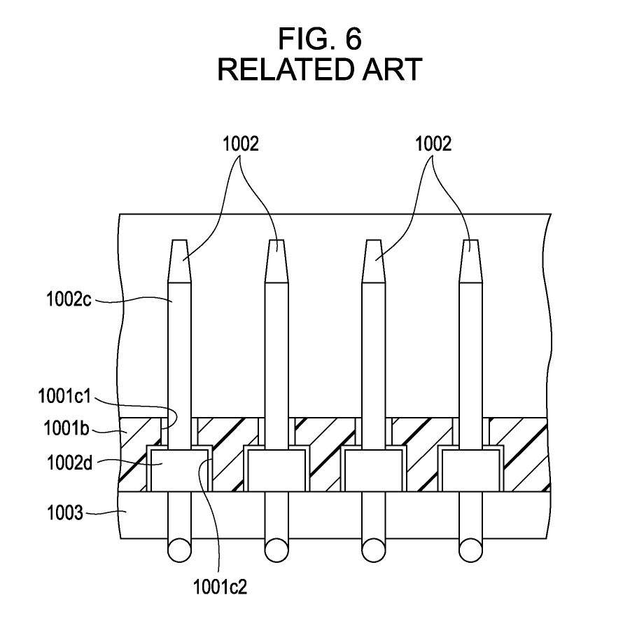

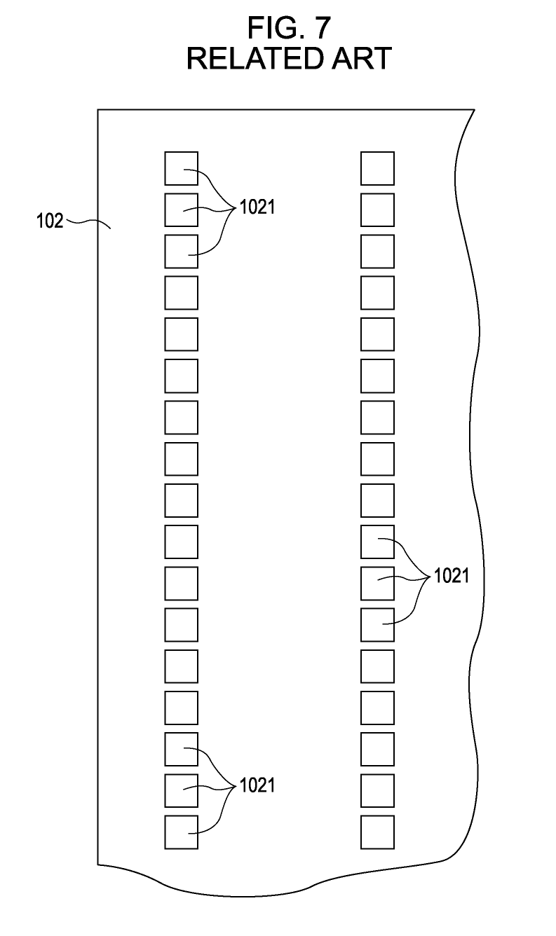

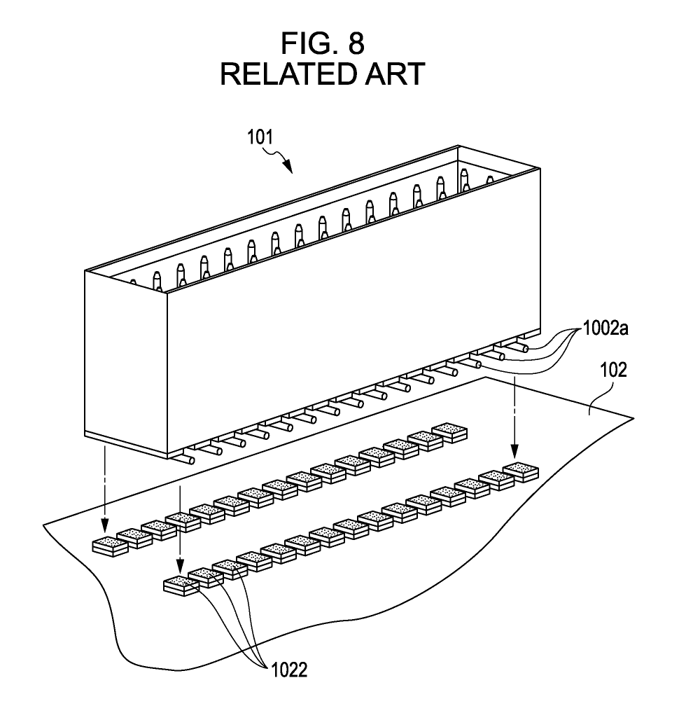

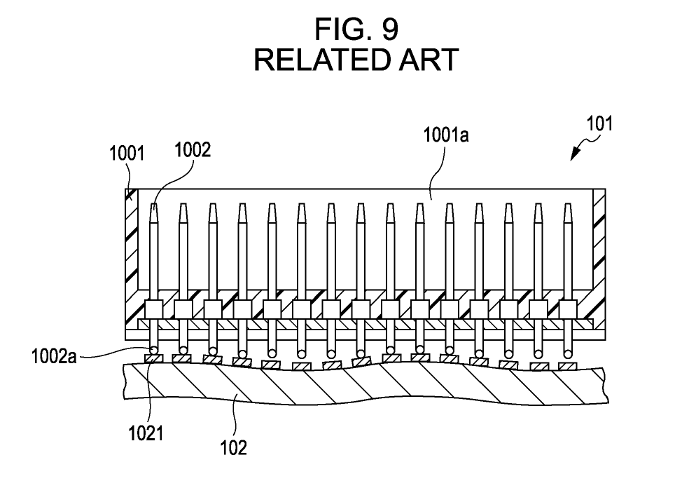

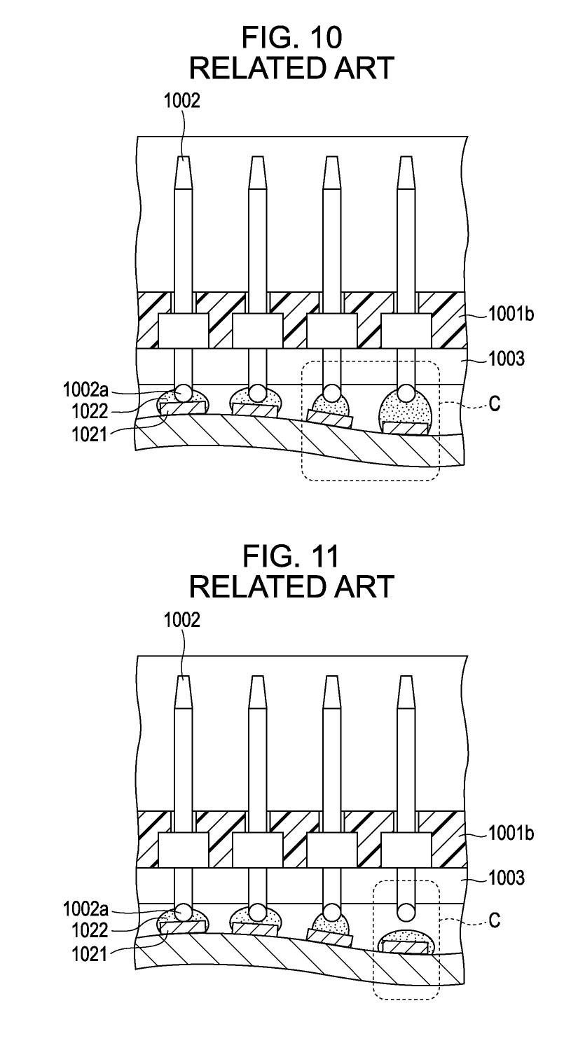

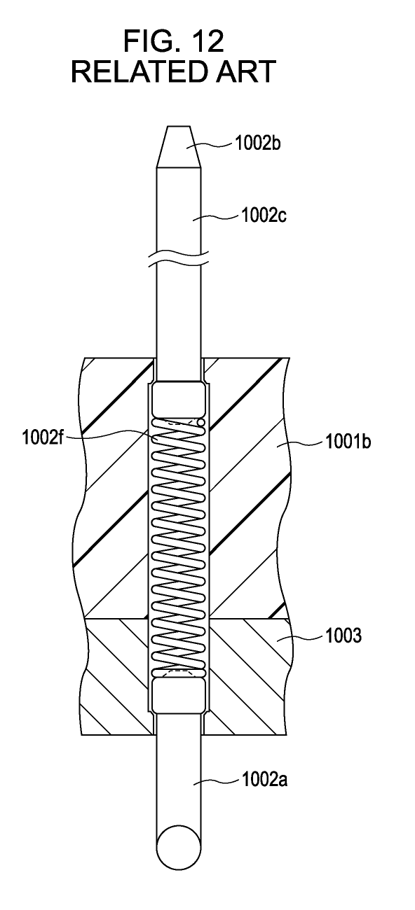

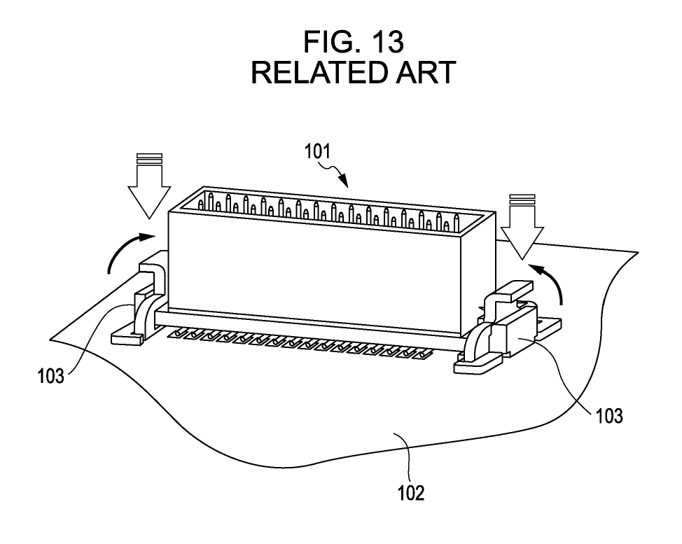

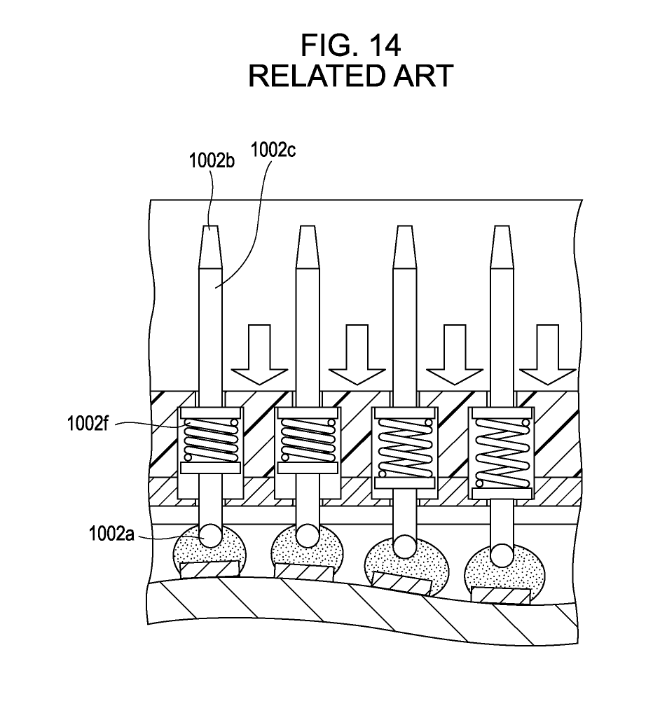

### DESCRIPTION OF EMBODIMENTS

The use of the pin connector 101 described above involves a space being secured on the substrate 102 for installing the lock mechanisms 103 near to where the connector 101 is mounted. As described above, it is preferable that the lock mechanisms 103 be tightly fastened to the substrate 102 since the lock mechanisms 103 generate such a force as to press the connector 101 against the substrate and to thus fix the connector 101 to the substrate. For this reason, the lock mechanisms 103 are often mounted on the substrate 102 with lock screws inserted from the back surface of the substrate 102 into through holes formed in the substrate 102. For this reason, spaces for the screws and the through holes have to be secured on the back surface of the substrate 102 in addition to the spaces for the lock mechanisms 103 on the front surface of the substrate 102. Thus, the area available for wires and the flexibility of arrangement of wiring are reduced. Forming through holes in a multilayer substrate, in particular, puts limitations on all the layers in terms of the area available for wires and the flexibility of arrangement of wiring.

In view of the above problems, the present disclosure is made to provide a surface-mount connector that imposes fewer limitations on wiring and that copes with the warpage of a substrate.

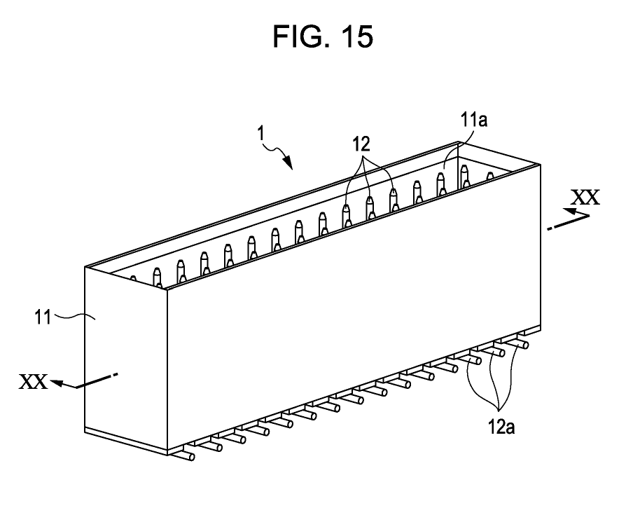

FIG. 15 is a perspective view of a pin connector 1, which is an example of a surface-mount connector according to an embodiment.

The pin connector 1 includes an enclosure 11 that has an open-top hollow portion 11a. Multiple pin terminals 12, which protrude upward, are arranged in two rows inside the hollow portion 11a. A receptacle connector, which is not illustrated and which is to be fitted into the pin connector 1, is inserted into the pin connector 1 from the open top, and thus the pin terminals 12 of the pin connector 1 fit into multiple terminals of the receptacle connector. The pin connector 1 also includes lower terminals 12a that penetrate through a bottom portion of the enclosure 11 and are bent sideward.

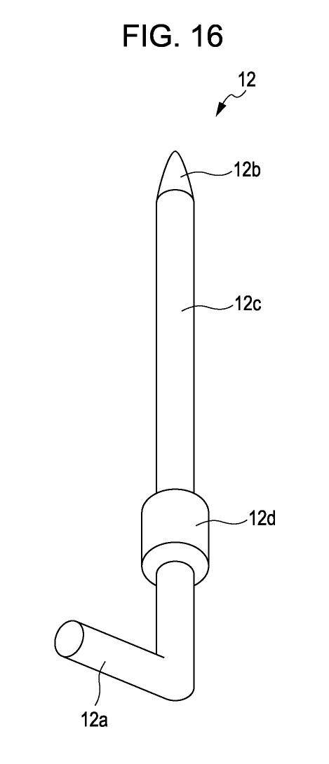

As illustrated in FIG. 16, each of the multiple pin terminals 12 is formed integrally with a corresponding one of the L-shaped lower terminals 12a. Specifically, each pin terminal 12 includes, in order from top to bottom, a pointed portion 12b that is tapered toward the top, a first cylindrical portion 12c, a second cylindrical portion 12d, and a lower terminal 12a formed by an L-shaped cylinder having a smaller diameter than the second cylindrical portion 12d.

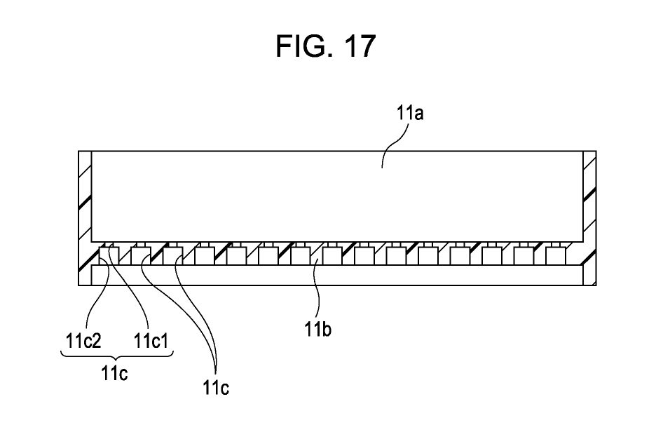

As illustrated in FIG. 17, a bottom plate 11b of the enclosure 11 has multiple through holes 11c that allow the pin terminals 12 to be inserted therethrough and to be fixed thereto. The through holes 11c are arranged so as to correspond to the arrangement of the pin terminals 12. Each through hole 11c includes a first cylindrical hole 11c1 that is open to the upper side of the bottom plate 11b, and a second cylindrical hole 11c2 that is open to the lower side of the bottom plate 11b and that has a larger diameter than the first cylindrical hole 11c1. The first cylindrical hole 11c1 and the second cylindrical hole 11c2 are connected to each other.

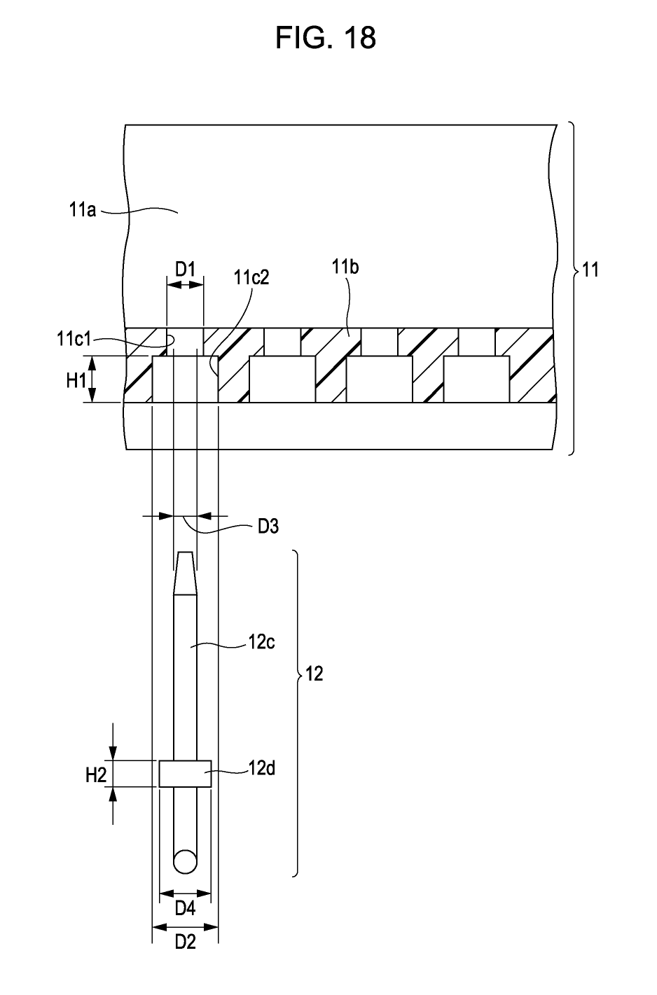

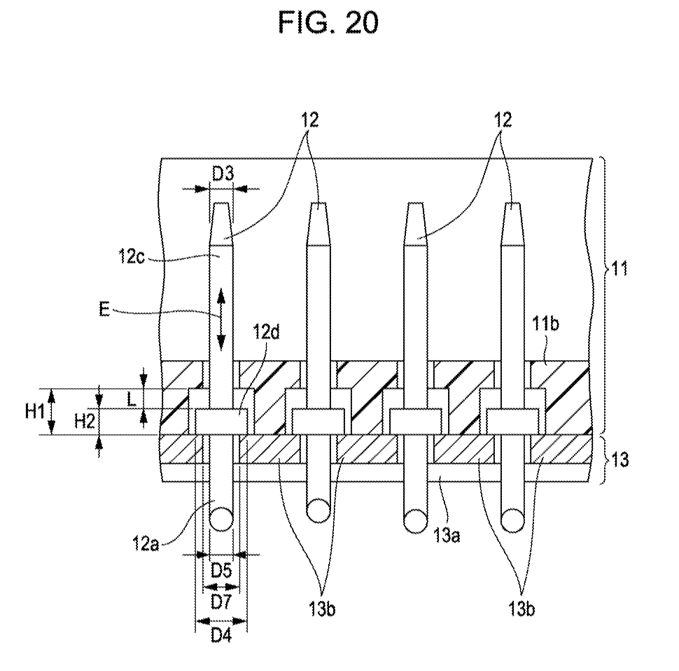

As illustrated in FIG. 18, an inner diameter D1 of each first cylindrical hole 11c1 is larger than a diameter D3 of the first cylindrical portion 12c of each pin terminal 12, but is smaller than a diameter D4 of the second cylindrical portion 12d of each pin terminal 12. The inner diameter D2 of each second cylindrical hole 11c2 is larger than the diameter D4 of the second cylindrical portion 12d of each pin terminal 12. The diameter D3 of the first cylindrical portion 12c of each pin terminal 12 is equal to a diameter D5 (see FIG. 20) of each lower terminal 12a.

In the embodiment, the inner diameter D1 of each first cylindrical hole 11c1 is set at 0.5 mm, the diameter D3 of the first cylindrical portion 12c of each pin terminal 12 and the diameter D5 of the lower terminal 12a of each pin terminal 12 are set at 0.4 mm, the inner diameter D2 of each second cylindrical hole 11c2 is set at 0.8 mm, and the diameter D4 of each second cylindrical portion 12d is set at 0.7 mm.

The height H2 of the second cylindrical portion 12d of each pin terminal 12 is smaller than the height H1 of each second cylindrical hole 11c2.

In the embodiment, the height H2 of the second cylindrical portion 12d of each pin terminal 12 is set at 0.3 mm and the height H1 of each second cylindrical hole 11c2 is set at 0.65 mm.

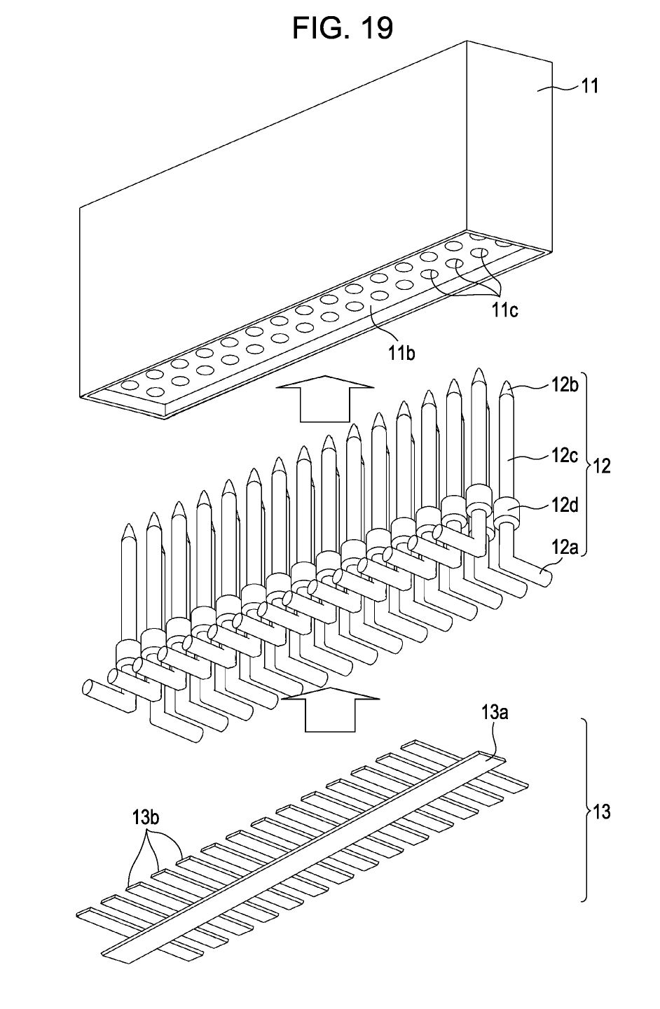

As illustrated in FIG. 19, the pin connector 1 is assembled by inserting the pin terminals 12 into the through holes 11c from the lower side of the bottom plate 11b of the enclosure 11, and then attaching a retaining board 13, which supports the inserted pin terminals 12 from underneath, to the bottom plate 11b from underneath.

The retaining board 13 includes a backbone portion 13a that is to be interposed between the rows of the pin terminals 12 and multiple arm portions 13b that are to be interposed between adjacent pin terminals 12.

FIG. 20 is an enlarged sectional view of the pin connector 1, taken along line XX-XX of FIG. 15.

Adjacent arm portions 13b of the retaining board 13 are separated from each other by a gap with a width D7. The width D7 is larger than the diameter D5 of the lower terminal 12a of each pin terminal 12 but smaller than the diameter D4 of each second cylindrical portion 12d (set at 0.5 mm, in the embodiment). Accordingly, when one pin terminal 12 is moved downward, the lower side of the second cylindrical portion 12d comes into contact with the upper sides of the arm portions 13b and thus the pin terminal 12 is restrained from being moved further downward.

As has been described with reference to FIG. 18 to FIG. 20, the second cylindrical portion 12d of each pin terminal 12 is restrained from being moved upward by a step defined by the first cylindrical hole 11c1 and the second cylindrical hole 11c2 and also restrained from being moved downward by coming into contact with the upper sides of the arm portions 13b.

The diameter D3 of the first cylindrical portions 12c and the diameter D5 of the lower terminals 12a of the pin terminals 12 are smaller than the inner diameter of the first cylindrical holes 11c1 used for housing, and the diameter D4 of the second cylindrical portions 12d of the pin terminals 12 is smaller than the inner diameter of the second cylindrical holes 11c2 used for housing. Thus, each pin terminal 12 is held while having a small contact resistance with the first cylindrical portion 11c1, the second cylindrical portion 11c2, and the arm portions of the retaining board 13.

In the above structure, each pin terminal 12 is held so as to be vertically (in directions indicated by arrow E of FIG. 20) movable by a distance L, which is a value obtained by subtracting the height H2 of the second cylindrical portion 12d from the height H1 of the second cylindrical hole 11c2 (L=H1−H2).

Next, how to mount the pin connector 1 on the substrate 2 will be described.

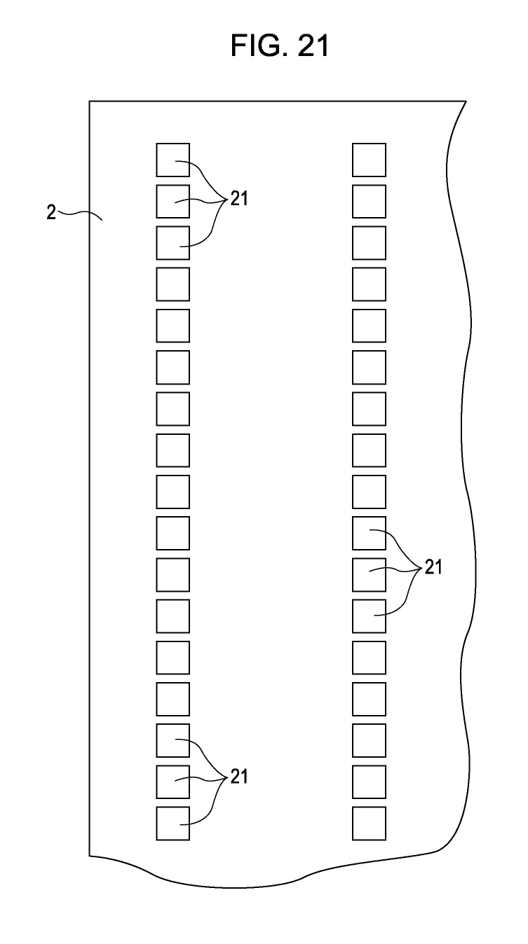

As illustrated in FIG. 21, electrically conductive patterns 21, which are arranged so as to correspond to the lower terminals 12a of the pin connector 1, are formed on the surface of the substrate 2 on which the surface-mount pin connector 1 is to be mounted. For convenience of illustration, FIG. 21 only illustrates the electrically conductive patterns 21, but other electrically conductive patterns including wirings that are connected to the electrically conductive patterns 21 are actually formed on the substrate 2.

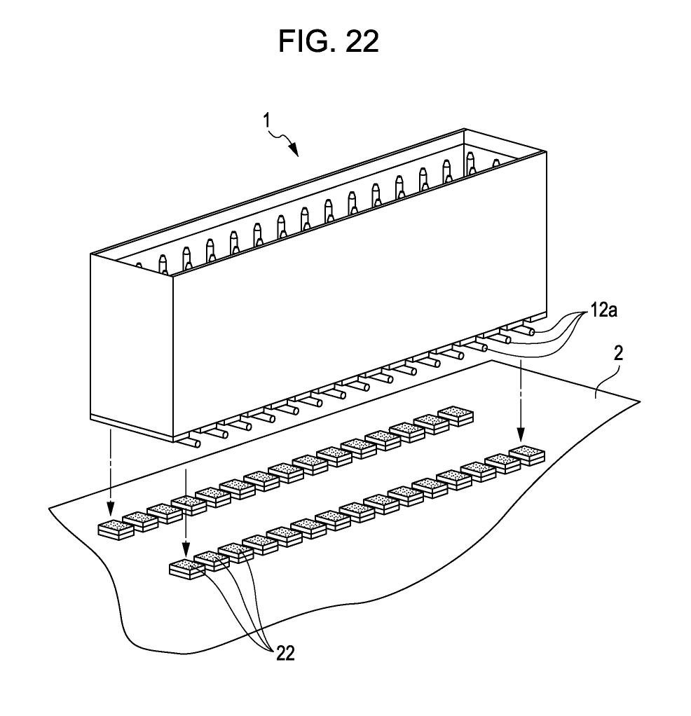

As illustrated in FIG. 22, the lower terminals 12a are placed on the electrically conductive patterns 21 to which soldering paste portions 22 are applied and then subjected to heating, so that the soldering paste portions 22 melt. Thus, the electrically conductive patterns 21 and the lower terminals 12a are joined to one another.

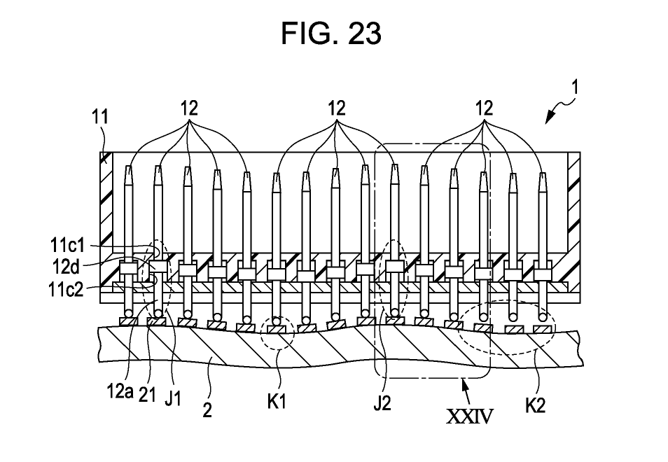

Referring now to the sectional view of FIG. 23, the state of the pin connector 1 that has been placed on a warped substrate 2 will be described.

As described above, the pin terminals 12 in the pin connector 1 are vertically movable before being placed on the substrate 2. When the pin connector 1 is placed on the substrate 2, an upper end of the second cylindrical portion 12d of each of the pin terminals 12 that come into contact with the electrically conductive patterns 21 positioned in or around the tops of the warped substrate (the electrically conductive patterns 21 located in regions 31 and 32 in FIG. 23) comes into contact with the step defined by the first cylindrical hole 11c1 and the second cylindrical hole 11c2. In other words, the pin terminals 12 located in these regions are held at a highest position within a movable range in the enclosure 1. Consequently, the pin terminals 12 located in the regions 31 and 32 support the connector 1.

Other pin terminals 12 are vertically movable by a distance L. Thus, as illustrated in FIG. 23, the lower terminals 12a descend along the warped substrate and thus come into contact with the corresponding electrically conductive patterns 21.

Nevertheless, each pin terminal 12 is only movable within the range of the above distance L. For this reason, a region (regions K1 and K2 in FIG. 23) may be produced that has warpage of an amount that is not compensated for with the movement of the pin terminals 12 by the distance L, that is, a region in which the lower terminal 12a and the corresponding electrically conductive pattern 21 do not come into direct contact with each other through a simple operation of placing the pin connector 1 on the substrate.

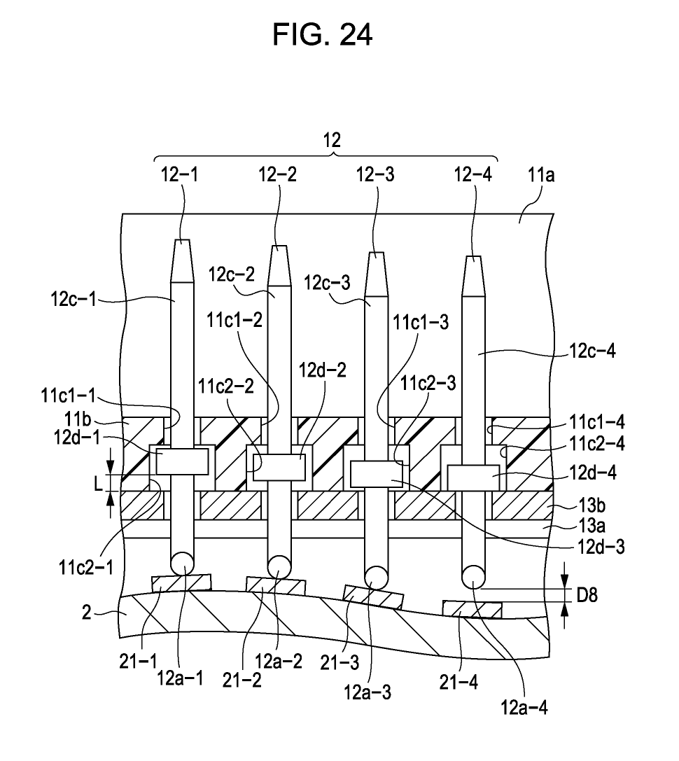

Referring to FIG. 24, a detailed description will be given of this point. FIG. 24 is an enlarged view of a region XXIV of FIG. 23.

For convenience, pin terminals 12 illustrated in FIG. 24 are denoted by 12-1, 12-2, 12-3, and 12-4 in order from the left of the plane of FIG. 24.

In accordance with the reference numerals 12-1 to 12-4 denoting the pin terminals, the components of the pin terminals 12-1 to 12-4 are denoted by reference numerals that correspond to those described from FIG. 15 to FIG. 22 and that are appended by “-1” to “-4”.

In addition, the second cylindrical holes 11c2 and the first cylindrical holes 11c1 that house the second cylindrical portion 12d-1 to 12d-4 of the pin terminal 12-1 to 12-4 and that are formed in the bottom plate 11b of the enclosure 11 will also be denoted by reference numerals appended by “-1” to “-4” in order from the left.

The electrically conductive patterns 21 that are brought into contact with the lower terminals 12a-1 to 12a-4 of the pin terminals 12-1 to 12-4 will also be denoted by reference numerals appended by “-1” to “-4” in order from the left.

As described above, the pin terminal 12-1 positioned in or around the top of the warped substrate 2 is held at the highest position within the movable range in the enclosure 1. The pin terminals 12-2 and 12-3 descend within the range of the distance L and thus come into contact with the electrically conductive patterns 21-2 and 21-3. On the other hand, the lower terminal 12a-4 of the pin terminal 12-4 fails to come into contact with the corresponding electrically conductive pattern 21-4, even when the lower side of the second cylindrical portion 12d-4 comes into contact with the arm portions 13b of the retaining board 13 (the distance between the lower end of the lower terminal 12a-4 and the electrically conductive pattern 21-4 at this time is denoted by D8).

As described above, however, the lower terminals 12a-1 to 12a-4 and the electrically conductive patterns 21-1 to 21-4 are respectively joined to one another by soldering. As described above, joining is performed by applying the electrically conductive patterns with soldering paste and then heating the substrate 2. The soldering paste melts and liquefies when heated. Generally, a thermosetting epoxy resin coating called a solder resist is applied to the surface of the substrate 2 except for at to-be-soldered regions. Since the solder resist repels melted solder, the solder resist keeps the soldering paste from adhering to regions other than the to-be-soldered regions and thus keeps adjacent electrically conductive patterns 21-1 to 21-4 from being short-circuited due to the melting of the soldering paste portions 22.

In FIG. 24, which illustrates the pin connector according to the embodiment, which is mounted on the substrate 2, the solder resist is applied to regions of the upper surface of the substrate 2 other than the regions corresponding to the electrically conductive patterns 21-1 to 21-4.

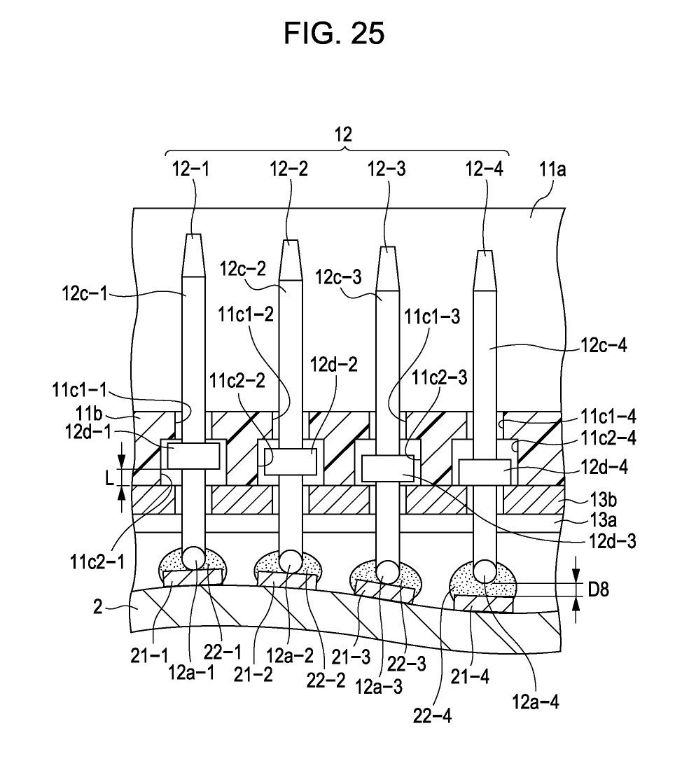

When the soldering paste portions 22-1 to 22-4 are melted in this state, the soldering paste portions 22-1 to 22-4 form balls on the respective electrically conductive patterns 22-1 to 22-4 as illustrated in FIG. 25, since the surface of the substrate 2 at regions other than the regions corresponding to the electrically conductive patterns 21-1 to 21-4 repels the soldering paste for the reason described above. Thus, the lower terminal 12a-4 and the electrically conductive pattern 21-4 are successfully joined even though there is a certain gap therebetween.

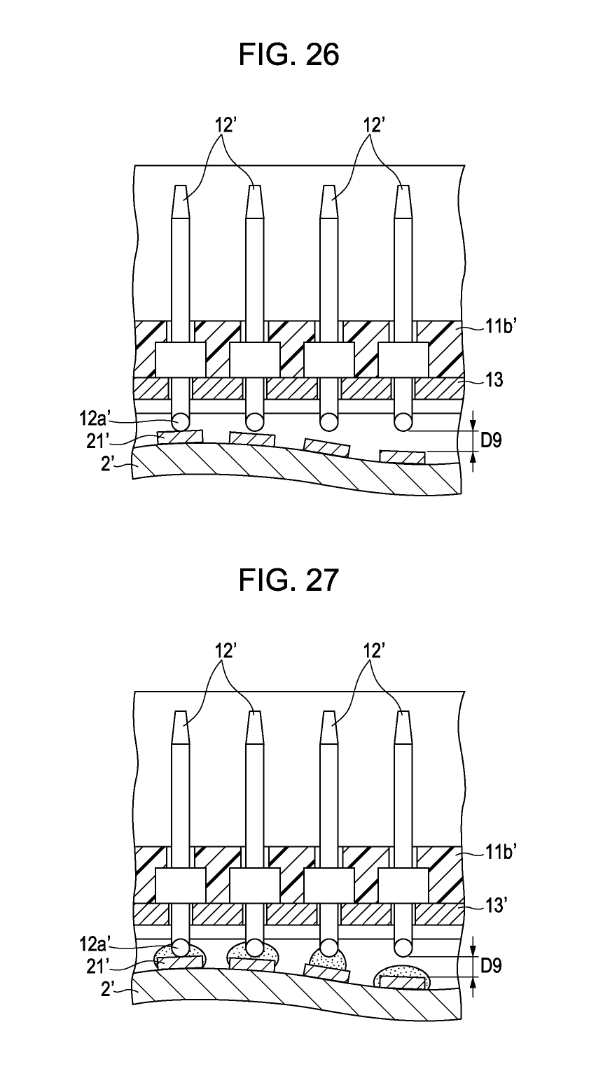

Referring now to FIG. 26, a description will be given of a comparison between the pin connector according to the embodiment and the pin connector of the related art in which the pin terminals 12 are not vertically movable. In FIG. 26, components corresponding to those of the embodiment are denoted by reference numerals appended by an apostrophe for convenience of illustration.

As illustrated in FIG. 26, the pin terminals 12′ other than the one on the far most left that is at the highest position fail to come into contact with the corresponding electrically conductive patterns 21′ since the pin terminals 12′ are not allowed to move downward unlike those in the embodiment.

As a result, the pin terminal 12′ on the far most right has a gap D9 between the lower terminal 12a′ and the corresponding electrically conductive pattern 21′, which is larger than the gap D8 of the embodiment between the lower terminal 12a-4 and the electrically conductive pattern 21-4.

In the embodiment, it has been described that the soldering paste portions 22 used for joining form balls, and thus enable joining despite the presence of a gap of a certain size. However, the size of the balls is limited. Thus, joining would fail if the gap were excessively large, as in the case of the pin terminal 12′ on the far most right in FIG. 27.

Thus, with the pin connector 1 according to the embodiment, the pin terminals 12 are reliably joined to the corresponding electrically conductive patterns formed on the considerably warped substrate, which do not allow the electrically conductive patterns thereon to be joined to the fixed pin terminals 12′ of the related art.

The pin connector 1 according to the embodiment has a structure in which the pin terminals 12 are simply made to be movable vertically. Since the pin terminals 12 descend along the warped substrate 2 due to gravity, the pin connector 1 copes with the warpage of the substrate 2. Thus, the pin connector 1 according to the embodiment does not have to use lock mechanisms for pressing the enclosure 11 of the pin connector 1 down toward the substrate, as in the known pin terminals including springs. Since the use of the pin connector 1 does not involve a space being secured on the substrate 2 for the lock mechanism, components and wiring patterns on the substrate 2 are allowed to be arranged with more flexibility.

In the embodiment, the difference between the diameter of the first cylindrical portion 12c of each pin terminal 12 and the inner diameter of each first cylindrical hole 11c1 and the difference between the diameter of the second cylindrical portion 12d of each pin terminal 12 and the inner diameter of each second cylindrical hole 11c2 are specified. These differences are determined in such a manner that the pin terminal 12 is vertically movable and that each pin terminal 12 is allowed to tilt to such an extent that the pin terminal 12 fits into the receptacle connector that fits into the pin connector 1. In other words, the above differences between the diameters and the inner diameters may be of any size, other than those specified in the embodiment, with which the pin terminal 12 is made vertically movable and with which each pin terminal 12 is allowed to tilt to such an extent that the pin terminal 12 fits into the receptacle connector that fits into the pin connector 1.

Moreover, the difference between the height of the second cylindrical portion 12d of each pin terminal 12 and the height of each second cylindrical hole 11c2 of the bottom plate 11b, that is, the vertically movable distance of each pin terminal 12 may be set as appropriate, depending on the size of the pin connector 1, the average amount of warpage of the substrate 2, or the like.

In the pin connector 1 according to the embodiment, the lower terminals 12a are vertically movable in response to changes in shape of the warped substrate 2 even after being joined to the electrically conductive patterns 21 by soldering. Accordingly, even when the shape of the warped substrate changes over time or due to relocation, the pin terminals 12 move vertically so as to follow the change. Thus, the solder is less likely to become detached from the pin connector with the change in shape of a warped substrate than in the case of the pin connector that includes the fixed pin terminals 12.

A pin connector has been described as an example in the embodiment, but the embodiment is also applicable to other surface-mount connectors including a receptacle connector.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A surface-mount connector comprising:
an enclosure; and
a plurality of terminals that is mounted in the enclosure, one end of each of terminals being joined to a surface of a substrate, another end of each terminal fitting into a terminal of a connector that is to be fitted into the surface-mount connector, wherein
each of the terminals is mounted in the enclosure so as to be movable within a restricted range in directions to come into contact with and separate from the substrate.

2. The surface-mount connector according to claim 1, wherein
the enclosure includes a plurality of through holes each including an upper opening and a lower opening that are narrower than an inside of the through hole,
the plurality of terminals each include a first portion that is wider than the diameter of the upper opening and the diameter of the lower opening of each through hole but equal to or narrower than the diameter of the inside of the through hole, and
the first portion of each terminal is housed in the inside of a corresponding one of the through holes.

3. A substrate unit comprising:
a substrate; and
a connector that is surface-mounted on the substrate, wherein the connector includes
an enclosure, and
a plurality of terminals that is mounted in the enclosure, one end of each terminal being joined to a surface of the substrate, another end of each of the terminals fitting into a terminal of a connector that is to be fitted into the connector surface-mounted on the substrate, and
each of the terminals are mounted in the enclosure so as to be movable within a restricted range in directions so as to come into contact with and separate from the substrate.

4. The substrate unit according to claim 3, wherein
the enclosure includes a plurality of through holes each including an upper opening and a lower opening that are narrower than an inside of the through hole,
the plurality of terminals each include a first portion that is wider than the diameter of the upper opening and the diameter of the lower opening of each through hole but equal to or narrower than the diameter of the inside of the through hole, and
the first portion of each terminal is housed in the inside of a corresponding one of the through holes.
